(19) United States
(12) Patent Application Publication
(10) Pub. No.: US 2025/0065956 A1
(43) Pub. Date: Feb. 27, 2025

(54) Silencer Unit for a Utility Vehicle

(71) Applicant: KNORR-BREMSE Systeme fuer Nutzfahrzeuge GmbH, Muenchen (DE)

(72) Inventors: Karsten SCHNITTGER, Muenchen (DE); Victor Javier MUNOZ LOU, Muenchen (DE)

(21) Appl. No.: 18/724,827

(22) PCT Filed: Dec. 27, 2022
(86) PCT No.: PCT/EP2022/087875

§ 371 Date: Jun. 27, 2024

(30) Foreign Application Priority Data
Jan. 17, 2022 (DE) 10 2022 101 010.4

(51) Int. Cl. B62D 25/18; B60T 17/00

(52) U.S. Cl. CPC B62D 25/18; B60T 17/008; B60Y 2306/09

(57) ABSTRACT

A silencer unit for a compressed-air system of a commercial vehicle, in particular a compressed-air brake system of a commercial vehicle, has at least one interface for connection to the brake system, in particular to an outflow duct of the brake system. The silencer unit has at least one air inlet and at least one air outlet, wherein the air outlet in the assembled state and the state of the silencer unit connected to the brake system, has an orientation which is not oriented vertically downward in the direction of the ground. A splashguard element is provided about and/or on the air outlet. Further, a compressed-air system for a commercial vehicle and a commercial vehicle are disclosed having a silencer unit.

### BACKGROUND AND SUMMARY

The present invention relates to a splashguard cover for a silencer unit for a commercial vehicle.

Commercial vehicles typically have pneumatic brake systems. The elements of these brake systems herein are also typically provided with compressed-air discharge ports by way of which the compressed air can be discharged from the system into the atmosphere.

This outflow duct is typically oriented vertically downward. When assembling the apparatus in the vehicle, a tolerance of +/−30° from the central axis of the apparatus to the vertical axis is often accepted, so that the discharge duct can also have this position in this instance.

Silencers are typically used in order to reduce the sound volume of the arising venting noise.

The central axis of the silencer herein is parallel to the axis of the outflow duct of the apparatus.

The silencer has a medium for noise abatement, in particular a wound knitted fabric.

Compressed air can be introduced on a first side of the medium for noise abatement by way of the interface of the apparatus to the motor truck brake system.

The compressed air can exit on the opposite second side, or laterally from the medium for noise abatement. The compressed air thus flows out downward and radially toward the side.

No splashguard is usually provided for the silencer, and the air can flow out into the void about the silencer.

When cleaning the apparatus from below using a pressure washer, water can make its way from the outside, in a straight line through the medium for noise abatement, into the outflow duct of the apparatus of the motor truck brake system. Trust is placed on the assumption that this water will then flow out downward again over the silencer due to gravity.

However, moisture or water in the silencer is problematic in particular at cold outside temperatures, because icing can occur in the silencer, causing the latter to freeze. In this instance, an outflow of air through the silencer can be impeded, or even rendered totally impossible, as a result. However, this compromises the serviceability of the air pressure treatment of the pneumatic brake system of the commercial vehicle, and may lead to a failure and mandatory maintenance of the brake system.

Silencer units for commercial vehicles are already known from the prior art.

For instance, DE 10 2013 016 084 A1 discloses a silencer for the venting unit of a compressed-air system, which has a control device housing having a housing base, wherein the housing base has a central duct connected to the main exhaust-air line of the compressed-air system, and adjacent thereto a space which is connected to a control exhaust-air line, and having a housing cover which has outlet openings and is removably connected to the housing base. The outflow direction herein is vertically downward in the direction of the ground (in terms of the assembled, operationally ready state).

Furthermore, a silencer for a compressed-air system of vehicles is known from EP 2 303 659 B1, which has a housing and a damping means, wherein the housing has an air inlet and an air outlet, and the damping means is disposed within the housing in such a way that the air flows from the air inlet to the air outlet through the damping means, noise damping being achieved in this way. The outflow direction herein is also again vertically downward in the direction of the ground (in terms of the assembled, operationally ready state).

EP 3 400 154 B1 discloses a silencer for a compressed-air system of a commercial vehicle, having a relief valve which operates in a non-destructive manner. The outflow direction herein is vertically downward in the direction of the ground (in terms of the assembled, operationally ready state).

Moreover, WO 2006/010400 A1 relates to a silencer for compressed-air systems, which has a tubular housing part with an air inlet and with inserted damping material. The damping material herein is in particular formed by a roll of knitted fabric. In the process, the supplied air is intended to flow tangentially to the damping material, or the roll of knitted fabric, respectively, and then be radially deflected within the housing part, and to flow out axially from an end of the tubular housing part.

It is therefore an object of the present invention to advantageously refine a silencer unit for a commercial vehicle of the type mentioned at the outset, in particular with a view to being able to prevent, or significantly reduce, the ingress of liquids and/or moisture into the silencer unit.

This object is achieved according to the invention by a splashguard cover for a commercial vehicle, having the features of the independent claim(s). It is accordingly provided that a splashguard cover for a silencer unit of a compressed-air system of a commercial vehicle is provided, in particular for a compressed-air brake system of a commercial vehicle, wherein the splashguard cover has walls which are disposed in the manner of a pagoda, and wherein outlet openings are in each case provided between the walls.

The compressed-air system is, in particular, a pneumatic treatment system of a commercial vehicle, in particular a compressed-air brake system of a commercial vehicle.

The invention is based on the fundamental concept that the ingress of liquid into the silencer unit can be reduced or prevented by a splashguard cover on the air outlet of a silencer unit. It is in particular provided herein that the outflow from the silencer unit takes place horizontally, and the splashguard cover is therefore specified and disposed in such a way that the cover prevents an ingress of liquid into a horizontally oriented outflow opening of a silencer opening (horizontal orientation to be understood in terms of the normal position in the assembled state when the commercial vehicle is on a horizontal plane). It arises in this instance that the outflowing air is not to be discharged vertically through and out of the silencer unit in the direction of the ground (in terms of the assembled, operationally ready state).

Moreover, it is to be achieved by the splashguard cover that no water, or little water, can invade the silencer unit. The walls of the splashguard cover, which are disposed in the manner of a pagoda, accordingly form a pagoda-like structure and are to be understood in such a manner that they form an assembly of, in particular circular, cover portions that lie on top of one another in the axial direction. The cover portions per se are in each case designed as round, in particular circular, plate elements. The cover portion (base cover portion) that in the assembled state is disposed closest to a housing of the silencer unit in the axial direction has the largest diameter. In the assembled state, further cover portions are disposed on this base cover portion in a stepped arrangement (stepped cover portions) so as to be aligned concentrically or eccentrically in relation to the latter. The diameter of each stepped cover portion decreases as the axial spacing in terms of the base cover portion increases. Alternatively however, other designs are also contemplated, such as an identical diameter, an increasing diameter, or convex or concave diameter steps (in each case in terms of an increasing axial spacing in terms of the base cover portion). The base cover portion as well as the stepped cover portions have inner axial apertures (through which the fluid can flow axially). However, a diameter of an inner axial aperture of a larger cover portion is in each case smaller than an external diameter of a next-smaller cover portion. The cover portion that is axially the most remote from the base cover portion forms the closure of the pagoda-like structure, whereby this cover portion does not have any inner axial aperture, so that this cover portion cannot be passed through by an axial flow. The walls, which are able to be designed as steps, between the individual cover portions furthermore have in particular radial outlet openings through which the fluid can flow out radially (as a partial flow). As a result of the plurality of pagoda-like cover portions (e.g. two, three, four, five or six portions), the previously described structure assists in repelling the ingress of splashing dirt and/or liquid that sprays in the direction of the splashguard cover. One or a plurality of outlet openings can in each case be disposed between the walls in the pagoda-like structure, said outlet openings being at least partially obscured by parts of the pagoda-like structure and enabling an outflow of air flowing out of the silencer unit in a simpler manner. The pagoda-like structure of the splashguard cover can be an integral design, which means simplified assembling. However, a design in multiple parts is also contemplated.

The silencer unit has an interface to an apparatus of the motor truck brake system. The apparatus of the motor truck brake system, e.g. part of the compressed-air brake system, has an outflow duct by way of which pressurized air can be introduced into the silencer unit. However, as opposed to being oriented vertically downward as customary nowadays, this outflow duct has another orientation, in particular also a horizontal orientation. Compressed air can be introduced on a first side of the medium for noise abatement via the interface to the apparatus of the motor truck brake system. The compressed air can exit from the opposite second side, or laterally, from the medium for noise abatement. The medium for noise abatement can be encompassed by a dedicated housing, or be integrated in a housing structure of the apparatus of the motor truck brake system. A splashguard is attached at a spacing from the medium for noise abatement, so as to be over the air exit regions, said splashguard permitting the simple outflow of the pressurized air. The splashguard is embodied in such a way that it releases large outflow cross section for the pressurized air and simultaneously prevents the water making its way from the outside, in a straight line through the medium for noise abatement, into the outflow duct of the apparatus of the motor truck brake system. An ingress of water (or else other liquids) is impeded, or even entirely prevented, as a result. The splashguard can be fastened to a housing encompassing the silencer, or be formed by a surface of another component which is situated at a suitable spacing from the air exit regions of the medium for noise abatement.

It can, in particular, be provided that the splashguard cover is designed so as to be able to be passed through by a flow of a fluid. It can be provided in particular herein that the splashguard element in the assembled state, is passed through by the fluid flowing out of the silencer unit. It is achieved as a result that no increased back pressure and resistance is built up by the splashguard element, and the outflow through the splashguard element is of a favorable design in terms of fluid dynamics.

The splashguard cover is used as a splashguard element.

Moreover, it can be provided that the splashguard cover has a substantially round basic shape. Uniform coverage can be achieved in a simple and reliable manner by a basic shape of this type. This shape is also favorable by virtue of the widely used round shapes in the context of silencers and the associated air outlets.

It can furthermore be provided that the splashguard cover has one or a plurality of latching cams. It is possible to assemble the splashguard cover without tools by means of the latching cams. It can be provided in particular that the splashguard cover by way of the latching cams can be snap-fitted in openings, in particular in openings in a perforated wall, or of a perforated wall portion.

It can be provided in particular that the splashguard cover has a plurality of rings and at least one end plate, which are disposed in the manner of a pagoda.

The arrangement of the rings and of the end plate can be in such a manner that a closed structure, similar to a roof, is derived when viewed from above. The adjacent elements can cover one another, as a result of which the water-repellent effect is improved. Sufficient spacings between the adjacent rings, or the penultimate ring and the end plate, can be disposed as a result of the pagoda-like structure, said spacings enabling corresponding outlet openings.

The splashguard cover can be made of plastics material.

It can be provided in particular that the splashguard element has a stepped cover with outlet openings, and/or is formed by a stepped cover with outlet openings. As a result of the stepped design, a plurality of outlet openings can be provided in the cover, and at the same time better shielding in relation to the ingress of water can be made possible as a result of the steps.

The cover can be used as an attachment for the perforated wall. For example, it is contemplated that such a cover is used when the air outlet of the silencer unit is comparatively exposed and is not additionally partially obscured or shielded by other elements, for example. Elements of this type may be, for example, chassis parts of the commercial vehicle, or else the drier cartridge of the compressed-air system, for example.

Moreover, it can be provided that the splashguard element is specified and designed in such a manner that the latter releases a sufficiently large outflow cross section for the pressurized air, and simultaneously prevents water from making its way from the outside in a straight line through the silencer unit into the outflow duct of the apparatus of the motor truck brake system. As a result, it is achieved that sufficient protection against spray water is provided, on the one hand. At the same time, it is ensured that the outflowing air from the silencer unit can flow out relatively unimpeded, on the other hand.

Moreover, it is contemplated that the splashguard element in its interior has a medium for noise reduction, in particular wherein the medium is passed through by the flow of the fluid passing through the silencer unit. It is particularly contemplated here that the medium can be a knitted fabric. The silencer thus has a medium for noise abatement, in particular a wound knitted fabric.

It can moreover be provided that the perforated wall is in direct contact with the medium for noise reduction. A compact construction mode is achieved as a result.

The present invention furthermore relates to a compressed-air system for a commercial vehicle. Accordingly, it is provided that the compressed-air system is designed for a commercial vehicle having at least one silencer unit as described above.

Moreover, the present invention relates to a commercial vehicle. Accordingly, it is provided that the commercial vehicle is designed with at least one compressed-air system as described above, or a silencer unit as described above.

Further details and advantages of the invention are now to be explained in more detail by means of an exemplary embodiment illustrated in the drawings.

### BRIEF DESCRIPTION OF THE DRAWINGS

FIG. 1 is a perspective view onto an exemplary embodiment of a compressed-air system for a commercial vehicle having exemplary embodiments of silencer units;

FIG. 2 is a sectional illustration of the silencer units according to FIG. 1, in the view from above;

FIG. 3 is a further sectional illustration of the silencer units according to FIG. 1, in the view from above;

FIG. 4 is a sectional illustration through the silencer unit for the trailer;

FIG. 5 is a sectional illustration of a section through the silencer unit for the tractor unit;

FIG. 6 is a view from above onto the splashguard cover according to one exemplary embodiment of the present invention; and

FIG. 7 is a lateral view onto the splashguard cover according to FIG. 6.

### DETAILED DESCRIPTION OF THE DRAWINGS

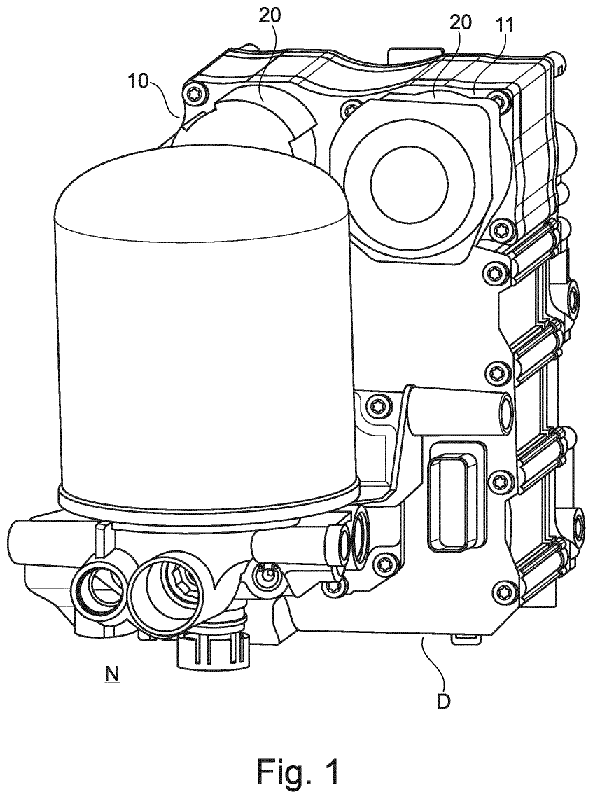

FIG. 1 shows a perspective view onto an exemplary embodiment of a compressed-air system D according to the invention for a commercial vehicle N, having two exemplary embodiments of silencer units 10, 11.

Here, a silencer unit 10 is provided for the trailer brake circuit, and a silencer unit 11 is provided for the brake circuit of the towing vehicle.

The compressed-air system D for the commercial vehicle N in the exemplary embodiment shown is the compressed-air brake system, or a pneumatic brake system, of a commercial vehicle.

The silencer unit 10 as well as the silencer unit 11 have the following features.

There exists an interface 12 to the compressed-air system D.

In the exemplary embodiment shown, the interface 12 is implemented by outlet openings 14 on the commercial vehicle, or outflow ducts 14 on the commercial vehicle, of the pneumatic brake system. The silencer units 10, 11 are placed in front of the outlet openings and suitably fastened to the compressed-air system D (presently with a plurality of screws and an assembly plate).

The silencer unit 10 and the silencer unit 11 have in each case at least one air inlet 16 and at least one air outlet 18.

The air outlet in the silencer unit 10 and the silencer unit 11, in the assembled state and the state of the silencer unit 10 or 11, connected to the compressed-air system D, has an orientation which is not oriented vertically downward in the direction of the ground (in terms of the assembled, operationally ready state). Instead, the outflow direction is parallel to the hard ground; the outflow direction thus being horizontal on a horizontally oriented hard ground.

Moreover, the silencer unit 10 and the silencer unit 11 have in each case one housing 20.

A medium for noise reduction 22, presently a wound knitted fabric 22, is in each case disposed in the housing 20.

During operation, a flow of the compressed air passes through the knitted fabric before the air exits the silencer.

Moreover, the knitted fabric is disposed in the housing 20 in such a way that it is at least partially in direct contact with the housing 20.

A splashguard element 24 is in each case provided about and on the air outlet 18 in front of each silencer unit 10 and silencer unit 11, presently specifically directly in front of the air outlet on the external side of the silencer unit 10 and silencer unit 11.

The splashguard element 24 is designed so as to be able to be passed through by a flow of fluid. It is provided herein for both silencer units, thus for the silencer unit 10 as well as the silencer unit 11, that the splashguard element 24 in the assembled state is passed through by the flow of fluid flowing out of the silencer unit 10, 11.

The splashguard element 24 on the silencer unit 10 as well as the silencer unit 11 is partially formed as a result of a perforated wall 26, or a perforated wall 30, being provided.

The perforated wall 26 or 30 herein is in each case formed by a housing portion of the silencer unit 10 or 11, respectively.

In the case of the silencer unit 10 for the trailer, the housing 20 is provided with a multiplicity of round holes or bores 28 in the portion having the perforated wall 26.

In the case of the silencer unit 11 for the towing vehicle, the housing 20 is provided with a multiplicity of circular-segment-type openings 32 in the portion having the perforated wall 30.

The portions having the perforated wall 26 or 30 are disposed on the silencer unit 10 for the trailer as well as on the silencer unit 11 for the towing vehicle in such a way that they are in direct contact with the knitted fabric 22.

A stepped cover 34 having outlet openings is provided as a further constituent part of the splashguard element in front of the portion having the perforated wall 30 of the silencer unit 11 for the towing vehicle.

The outlet openings of the stepped cover 34 herein are only horizontally disposed (in terms of the assembled, operationally ready state, whereby the commercial vehicle is on a flat hard ground).

The cover 34 herein is designed as an attachment on the external side of the wall of the housing 20 of the silencer unit 11 for the towing vehicle. Said cover 34 is snap-fitted in the openings of the perforated wall 30.

A cover is not required here because the perforated wall 26 of the silencer unit 10 is covered by adjacent elements (presently the drier cartridge) or components. The ingress of liquid into the silencer unit 10 is thus already sufficiently reduced, or even prevented, by the perforated wall 26 with its comparatively small holes (in particular in comparison to the perforated wall 30 of the silencer unit 11).

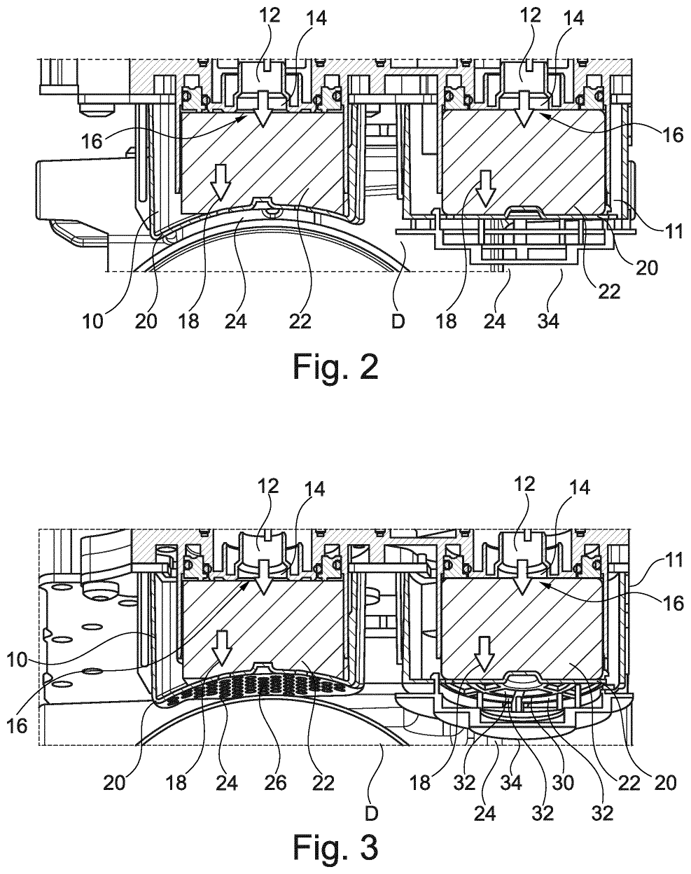

This can be seen in detail in particular in FIG. 2 to FIG. 5.

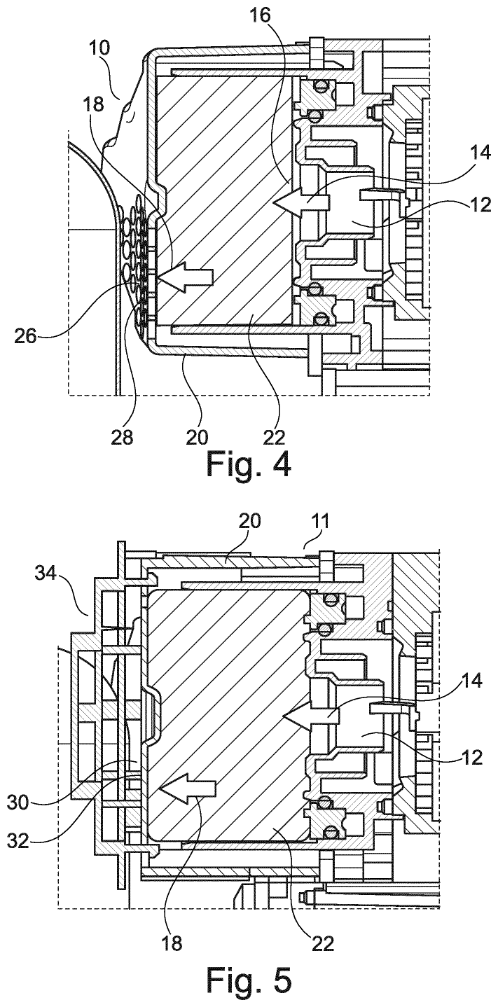

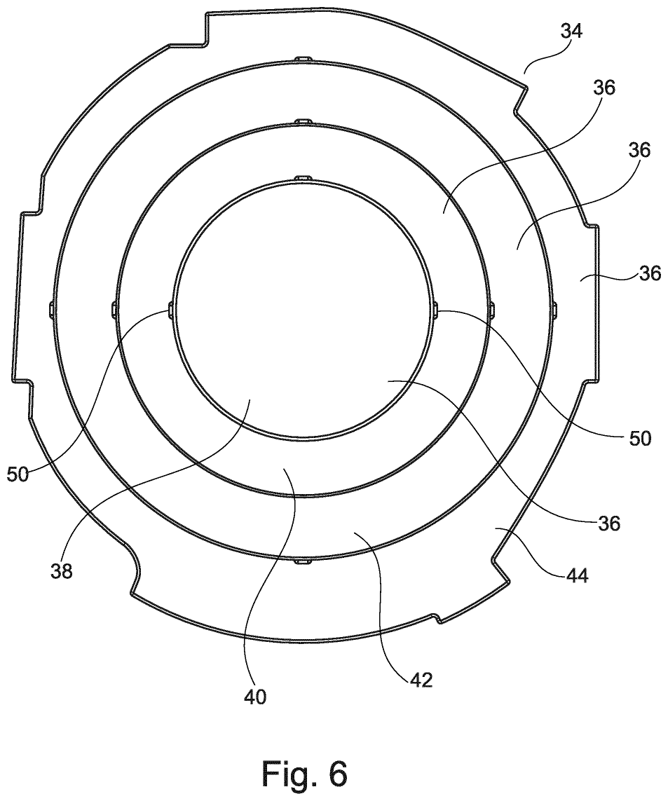

FIG. 2 shows a sectional illustration of the silencer units according to FIG. 1 in the view from above, and FIG. 3 shows a further sectional illustration of the silencer units according to FIG. 1 in the view from above. FIG. 4 shows a sectional illustration through the silencer unit 10 for the trailer. FIG. 5 shows a sectional illustration through the silencer unit 11 for the tractor unit.

The function of the silencer units 10 and 11 can be described as follows.

When compressed air has to be discharged toward the atmosphere from the compressed-air circuit for the trailer, this can take place via the silencer unit 10. The outflow of the compressed air herein is performed horizontally and not vertically in the direction of the hard ground.

This applies likewise to the compressed-air circuit for the tractor unit; here, the compressed air is delivered via the silencer unit 11.

Both silencer units 10 and 11 herein are provided with the splashguard elements 24 which impede the ingress of water into the silencer units.

Due to being covered by adjacent elements and components, the silencer unit 10 requires less splash protection than the silencer unit 11 which, in comparison, rather lacks protection by adjacent elements and components. For this reason, the cover 34 is additionally provided for the silencer unit 11.

It can be stated in general that the splashguard elements are specified and designed in such a manner that they release a sufficiently large outflow cross section for the pressurized air and simultaneously prevent water from making its way from the outside in a straight line through the silencer unit into the outflow duct of the apparatus of the motor truck brake system. As a result, it is achieved that sufficient protection against spray water is provided, on the one hand. At the same time, it is ensured that the outflowing air from the silencer unit can flow out relatively unimpeded, on the other hand.

It is simultaneously prevented that water can make its way from the outside in a straight line through the silencer unit 10 or 11 into the outflow duct of the apparatus of the motor truck brake system.

FIG. 6 shows a view from above onto the splashguard cover 34 according to one exemplary embodiment of the present invention.

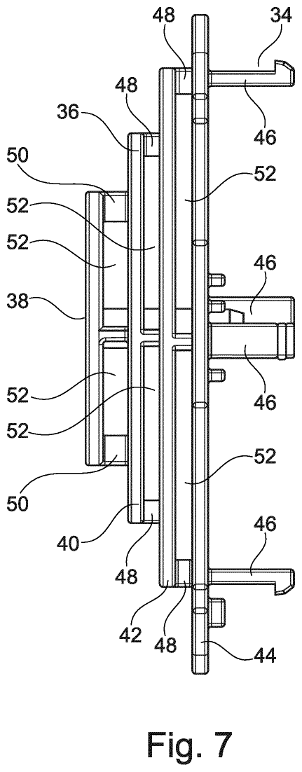

FIG. 7 shows a lateral view onto the splashguard cover 34 according to FIG. 6.

The splashguard cover 34 is the stepped cover 34 shown in FIG. 1 to FIG. 3 and FIG. 5. The splashguard cover 34 has outlet openings 52 and is provided for the silencer unit 11 of the compressed-air system D of the commercial vehicle N.

The splashguard cover 34 has walls 36 which are disposed in the manner of a pagoda, and outlet openings 52 are in each case provided between the walls 36.

In terms of the assembled state, the splashguard cover 34 externally on the end side has an end plate 38.

The end plate 38 is furthermore connected to a ring 40, specifically via a connecting web 50.

The connecting web 50 herein is higher than the connecting webs 48, so that the spacing from the end plate 34 to the adjacent ring 40 is greater than that of the further rings 42 and 44, which are connected via the connecting webs 48.

Splashguard cover 34 furthermore has latching cams 46.

The splashguard cover 34 is latched into the perforated wall 30 and snap-fitted in the latter without tools by means of the latching cams 46.

### LIST OF REFERENCE SIGNS

10 Silencer unit (trailer)
11 Silencer unit (towing vehicle)
12 Interface
14 Outflow duct (on commercial vehicle)
16 Air inlet (on silencer)
18 Air outlet (on silencer)
20 Housing (silencer)
22 Medium for noise reduction
24 Splashguard element
26 Perforated wall (with bores, trailer)
28 Bores in perforated wall
30 Perforated wall (with circular-segment-type openings, towing vehicle)
32 Circular-segment-type openings
34 Cover, splashguard cover
36 Walls
38 End plate
40 Ring
42 Ring
44 Ring
46 Latching cam
48 Connecting web
50 Connecting web
52 Outlet openings
N Commercial vehicle
D Compressed-air system

1.-9. (canceled)

10. A splashguard cover for a silencer unit of a compressed-air system of a commercial vehicle, comprising:
walls of the splashguard cover which are disposed in a pagoda-shaped manner; and
outlet openings which are, in each case, provided between the walls.

11. The splashguard cover according to claim 10, wherein
the splashguard cover has a substantially round basic shape.

12. The splashguard cover according to claim 10, wherein
the splashguard cover has one or a plurality of latching cams.

13. The splashguard cover according to claim 10, wherein
the splashguard cover has a plurality of rings and at least one end plate, which are disposed in the pagoda-shaped manner.

14. The splashguard cover according to claim 10, wherein
the splashguard cover is a stepped cover with outlet openings.

15. The splashguard cover according to claim 10, wherein
the splashguard cover is specified and configured so as to release a sufficiently large outflow cross section for pressurized air and simultaneously prevent water ingressing from outside in a straight line through the silencer unit into an outflow duct of an apparatus of a motor truck brake system.

16. A silencer unit for a compressed-air system of a commercial vehicle, comprising:
at least one splashguard cover according to claim 10, wherein
the at least one splashguard cover is mounted on the silencer unit.

17. A compressed-air system for a commercial vehicle, comprising:
at least one splashguard cover according to claim 10; and
a silencer having the splashguard cover.

18. The compressed-air system according to claim 17, wherein the compressed-air system is a compressed-air brake system of the commercial vehicle.

19. A commercial vehicle comprising a compressed-air system according to claim 17.
